(19) United States
(12) Patent Application Publication
(10) Pub. No.: US 2012/0249081 A1
(43) Pub. Date: Oct. 4, 2012

(54) BALANCED ENERGY AND ENERGY PRODUCING SYSTEM

(76) Inventor: Hung Jui-Tung, Dacun Township (TW)

(21) Appl. No.: 13/435,516

(22) Filed: Mar. 30, 2012

(30) Foreign Application Priority Data
Mar. 31, 2011 (CN) PCT/CN2011/072345

(51) Int. Cl. H02J 7/00

(52) U.S. Cl. 320/137

(57) ABSTRACT

A balanced energy and energy producing system is composed of an input device with a driven generator connected thereto. The signal of the generator actuates a controller having multiple grading parameters and battery monitoring parameters. The controller supervises the generator to supply the electrical energy needed for the battery and also, based on the strength of the generator signal, drives an output device up to a predetermined power rating according to the multiple grading parameters so as to establish an uprated power source management system applicable to hybrid power source electro mobiles, including bicycles, and domestic power generation thereby achieving efficient energy utilization.

### BACKGROUND OF THE INVENTION

1. Field of the invention

The present invention relates to a small sized, high power, low carbon emission generating system and, in particular, to a balanced energy and energy producing system.

2. Description of the Prior Art

Environmental protection is one of the most important considerations of all global problems. This stimulated the rapid development of generating systems for bulk wind power, solar energy and tidal power. All of these installations require a large amount of investment. Rapid increase of the world population, concentration of the population to particular areas, and the need for natural resources have contributed to a severe problem of environmental contamination. Accordingly, authorities suggest the use of hybrid power vehicles as electro mobiles (bikes) for short distance transportation instead of depending on vehicles which consume petroleum-based oil fuel, so as to help alleviate environmental pollution.

Incidentally, hybrid power vehicles are still very expensive for an ordinary consumer to use even though local government may grant a small subsidy as financial aid to encourage their use.

However, due to continuously rising oil prices and growing environmental awareness, many people are now aware of the importance of saving energy in order to help our planet. For short distance transportation such as daily attendance at an office or school, or for going on an excursion at leisure, people realize that taking public transportation facilities and electro mobiles (bikes) are a clever choice for saving money instead of using the traditional petroleum consuming private vehicles.

Present-day electro mobiles generally take 8 to 10 hours to recharge their battery to run about 50 km (30 km in case of bikes) at a time. Although this capability is enough for a short distance journey, a longer running time before needing to recharge the battery is preferable.

### SUMMARY OF THE INVENTION

It is the main object of the present invention to provide a balanced energy and energy producing system which can make use of hybrid power to develop a medium or small size high power generating system to supply power to electro bikes or domestic electrical appliances, or even to establish a medium or small size electric power plant using wind driven power or solar energy generation, so as to supply power for local domestic use and reduce carbon emissions

To achieve the above object, the balanced energy and energy producing system provided by the present invention is composed of an input device with a driven generator connected thereto. The signal of the generator actuates a control device having many stages (multiple grading) of parameters and a battery monitoring parameter. The control device supervises the generator to supply the electrical energy needed for a battery unit and, based on the strength of the generator signal, drive an output device up to a predetermined power rating according to the many stages of parameters so as to establish an uprated power source management system applicable to a hybrid power source, electro mobiles including bikes, and domestic power generation, thereby achieving an efficient utilization of energy.

### BRIEF DESCRIPTION OF THE DRAWINGS

The drawings disclose an illustrative embodiment of the present invention which serves to exemplify the various advantages and objects hereof, and are as follows:

FIG. 1 is an operation flow chart of the present invention.

FIG. 2 is an illustrative drawing showing how to dispose the component parts of the present invention on an electro mobile bike.

FIG. 3 is a schematic view showing how the system of the present invention is applied to a hybrid power driven vehicle.

FIG. 4 is a schematic view showing how the system of the present invention is applied to receive the power generated by a wind driven generator.

FIG. 5 is an illustrative drawing showing how the incorporated power produced by a wind drive generator and a solar collector is supplied to an electro mobile (bike).

FIG. 6 is a schematic view showing the layout of the component parts of the present invention.

FIG. 7 is an illustrative drawing showing how the system of the present invention is applied to a hydrogen fuel cell.

FIG. 8 is a schematic view showing control of the present invention.

FIG. 9 is a schematic view showing how to distribute the energy produced by the present invention.

FIG. 10 is a waveform diagram of the input device charging the battery unit.

FIG. 11 is a waveform diagram of the battery unit discharging to the output device.

### DETAILED DESCRIPTION OF THE PREFERRED EMBODIMENT

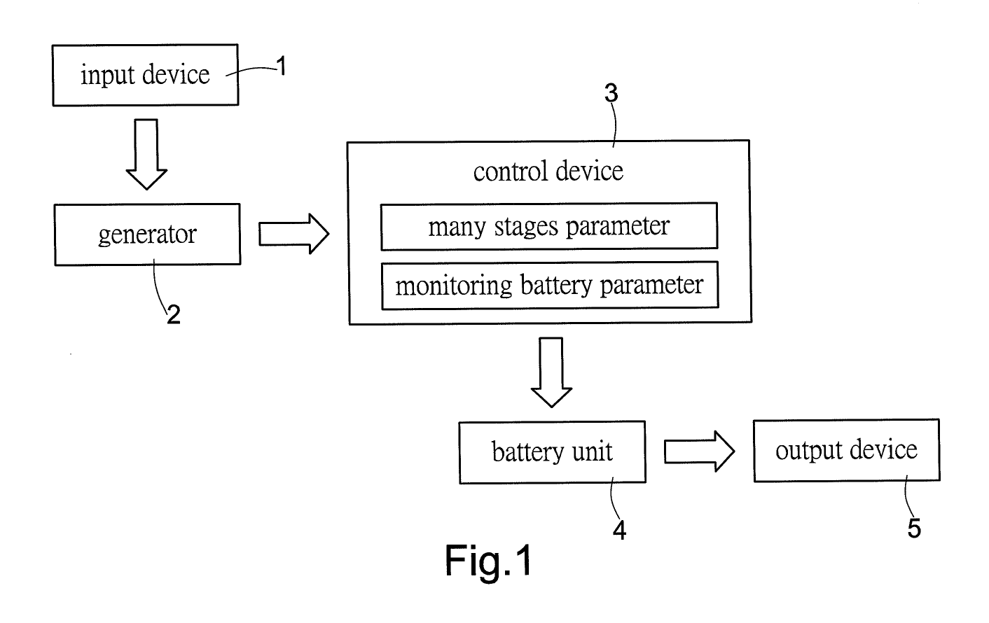

Referring to FIG. 1, the balanced energy and energy producing system of the present invention is essentially composed of an input device 1 connected to a driven generator 2. A signal of the generator 2 is used to actuate a control device 3, which has many stages (unlit grading) parameters and a battery monitoring parameter. The control device 3 supervises the generator 2 to supply the electric energy needed for a battery unit 4 and, based on the strength of the generator signal, drives an output device 5 up to a rated output value according to the many stages of parameters. The control device 3 is able to detect the drive capability of the output device 5. If the output device 5 is a motor driven device, the control device 3 detects the revolution speed of the motor and, if the output device 5 is a domestic electric appliance, its current value will be detected.

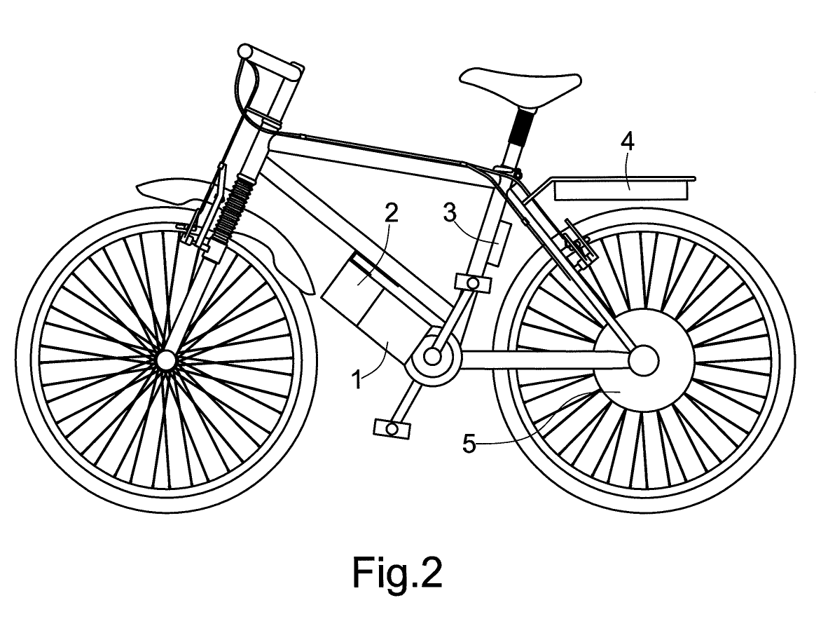

Referring to FIG. 2, the input device 1 is a speed change device, and the input device 1 and generator 2 are equipped on an electro mobile bike. The power produced by manual pedaling action is inputted into the input device 1 to drive the generator 2 which in turn charges the battery unit 4. The battery unit 4 then delivers its power to the output device 5 (motor) to drive the latter which in turn drives the electro mobile bike to run. In the system, the control device 3 plays the role of regulating the strength of current of the output device (motor) 5 according to many stages of parameters and, based on the signal strength of the generator 2, so as to drive the output device (motor) 5 in a selective transmission manner until reaching a predetermined rated output speed. The control device 3 further detects the operating speed of the output device 5 and the signal strength of the generator 2 so as to make the control device 3 regulate the strength of the current output of the battery unit 4 to the output device 5 according to the many stages of parameters, thereby driving the output device (motor) 5 in a selective transmission manner. The output device (motor) 5 under operation then indicates to the control device 3 to regulate its rotational speed with the many stages of parameters until the speed of the output device (motor) 5 reaches a predetermined rated value. According to the present invention, the electro mobile bike driven as such does not require any chain, belt or transmission shaft. Instead, the generator 2 is driven by directly or indirectly producing manual pedaling power, whereby the signal of the generator 2 is sent to the control device 3 to drive the motor 5, and the power of the battery unit 4 is supplied to the motor 5. After running, the speed of the motor 5 is determined by the signal of the generator 2 and part of the running power of the motor 5 is fed back to the battery unit 4. This primitive man-powered and operated electro mobile bike can therefore provide a low carbon footprint without losing its original effect.

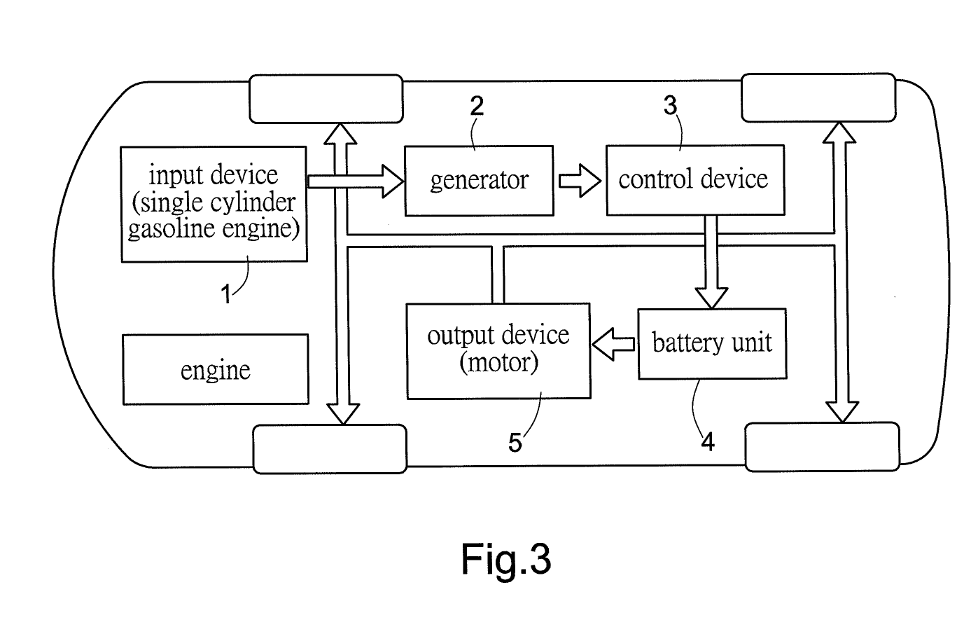

Referring to FIG. 3, the system of the present invention is applied to a hybrid power driven vehicle. The input device 1, which is a 25 cc single cylinder gasoline engine, drives the generator 2 which in turn charges the battery unit 4. The control device 3 equipped on the system supervises the output power of the battery unit 4 to drive the output device (motor) 5, thereby enabling this hybrid power driven vehicle to run.

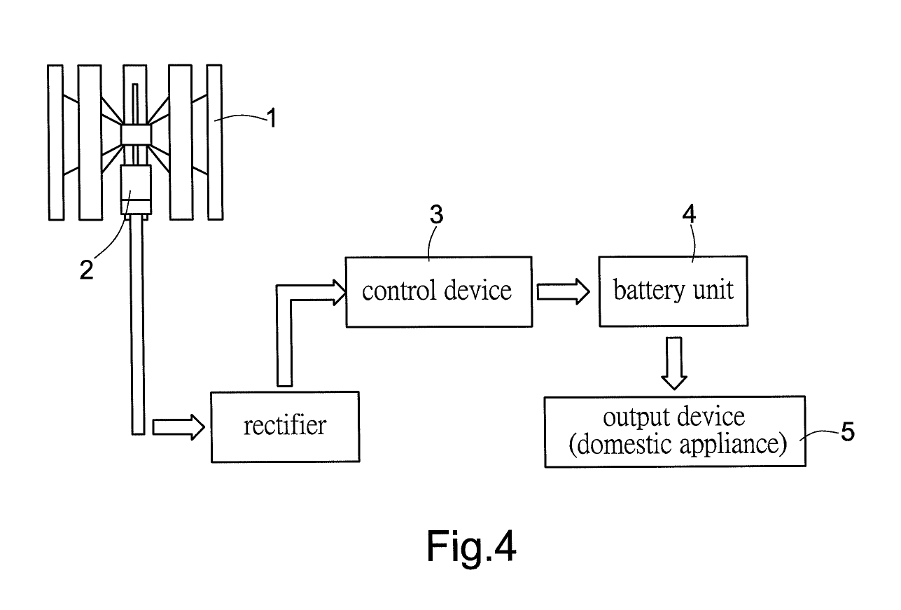

Referring to FIG. 4, the system of the present invention is applied to receive the power generated by a wind driven generator. The input device 1, which is a wind drive generator or a solar collector, supplies its produced electricity into the battery unit 4 through the control of the control device 3. The produced electricity is then used to operate a domestic small size 3C electronic product or a domestic electrical appliance. If the output device 5 is a domestic electrical appliance, the signal strength of the generator 2 is able to let the control device 3 regulate the strength of current of the battery unit 4 supplying the output device (domestic appliance) 5 according to the many stages of parameters, thereby permitting the latter to operate with its rated output current.

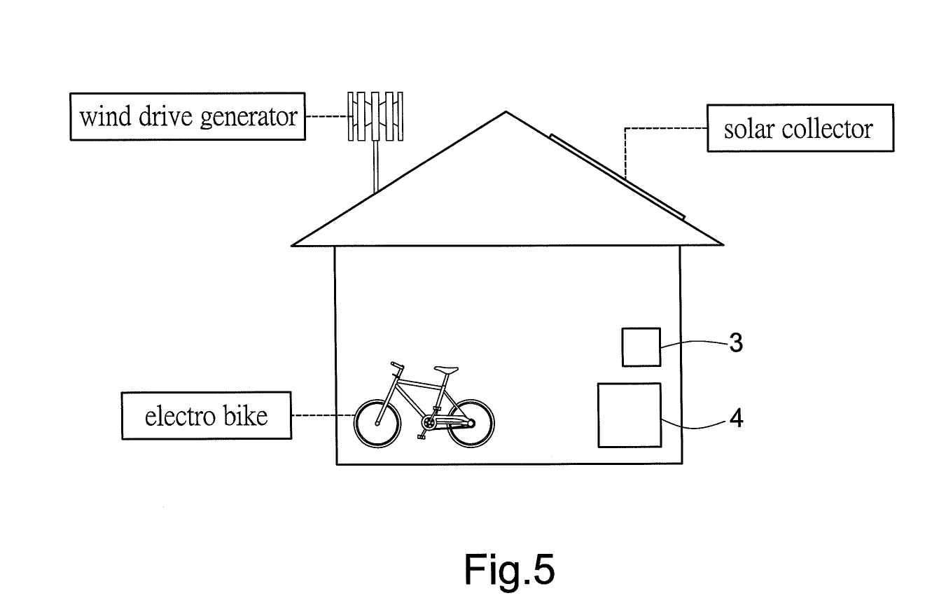

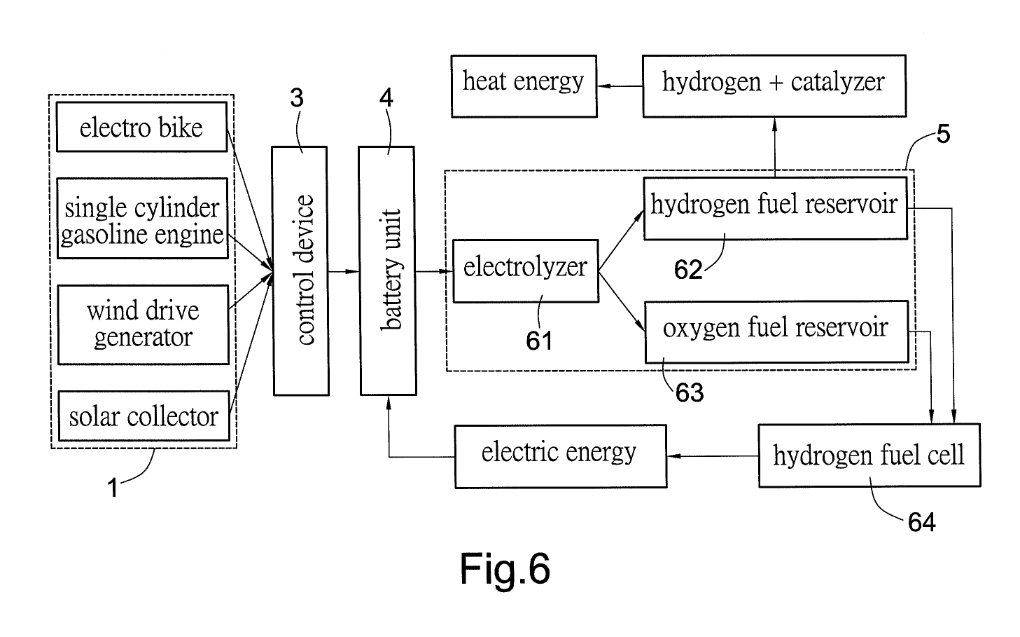

Referring to FIG. 5 and FIG. 6, the electricity produced by the wind drive generator, the solar collector, and the electro mobile bike is stored in the battery unit 4 which, in turn, supplies the power to the output device 5. In this system, the output device 5 is an electrolyzer 61, which can perform an electrolyzing process in an electrolytic cell. The electrolytic cell further consists of a positive electrolyzer 61 and a negative electrode 62 immersed in a solution containing positive and negative ions. The positive and negative electrodes 61, 62 are for producing oxygen and hydrogen.

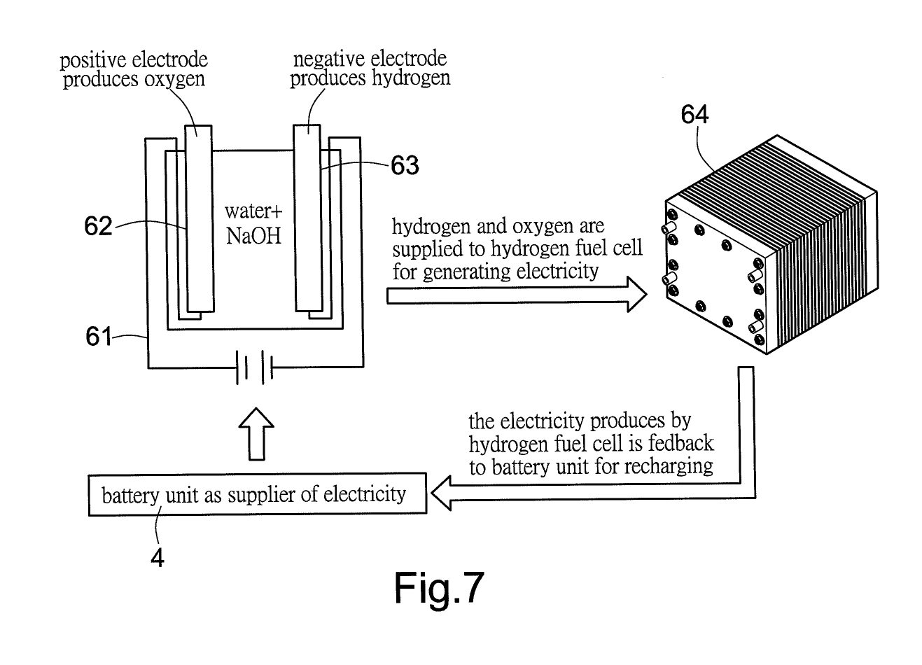

Referring to FIG. 7, the control device 3 can further control the production process of oxygen and hydrogen and supply them to a hydrogen fuel cell 64. The positive and negative electrodes 61, 62 are connected to an oxygen fuel reservoir and a hydrogen fuel reservoir. The two reservoirs are respectively connected to a positive pole and a negative pole of the hydrogen fuel cell 64 so as to allow the cell 64 to output electricity continually.

Returning to FIG. 5, in addition to supplying the hydrogen fuel cell 64, the hydrogen produced by the electrolyzer 61 can react with a catalyzer to transform its reaction energy into heat for use in room heating. In the energy producing system of the present invention, the control device 3 controls the output current of the battery unit 4 and determines the output of the electrolyzer 61. Moreover, the utility factor of the hydrogen and the oxygen produced by the electrolyzer 61 can be determined. Similarly the heat energy produced by burning the catalyzer can also be controlled or maintain the temperature of the heat energy in a fixed range.

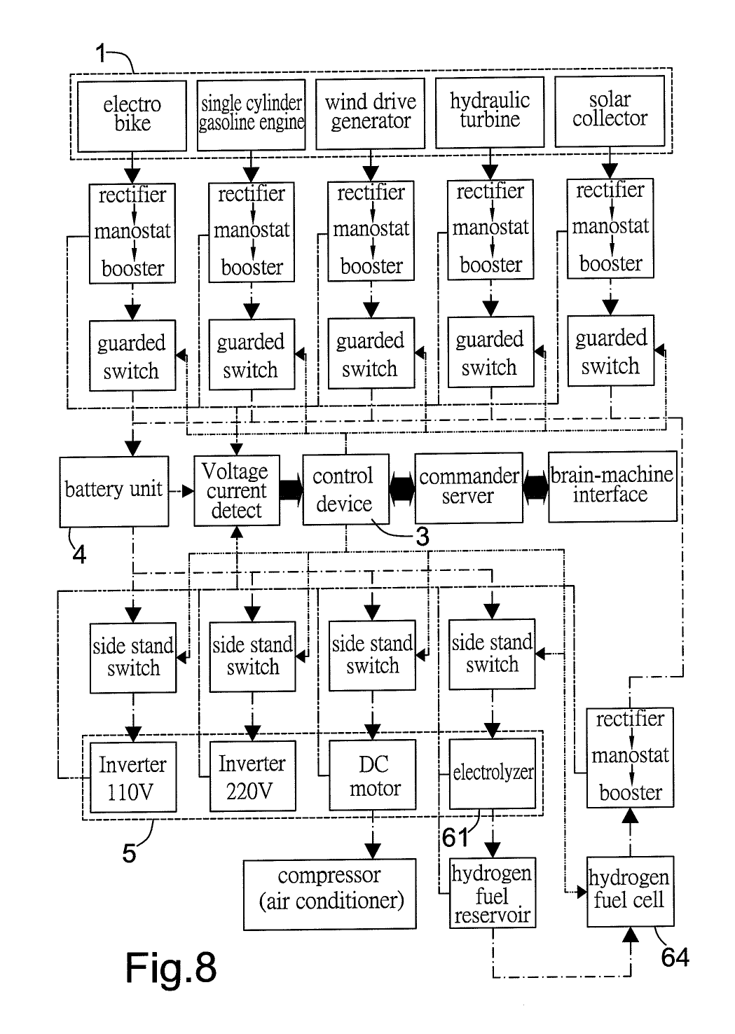

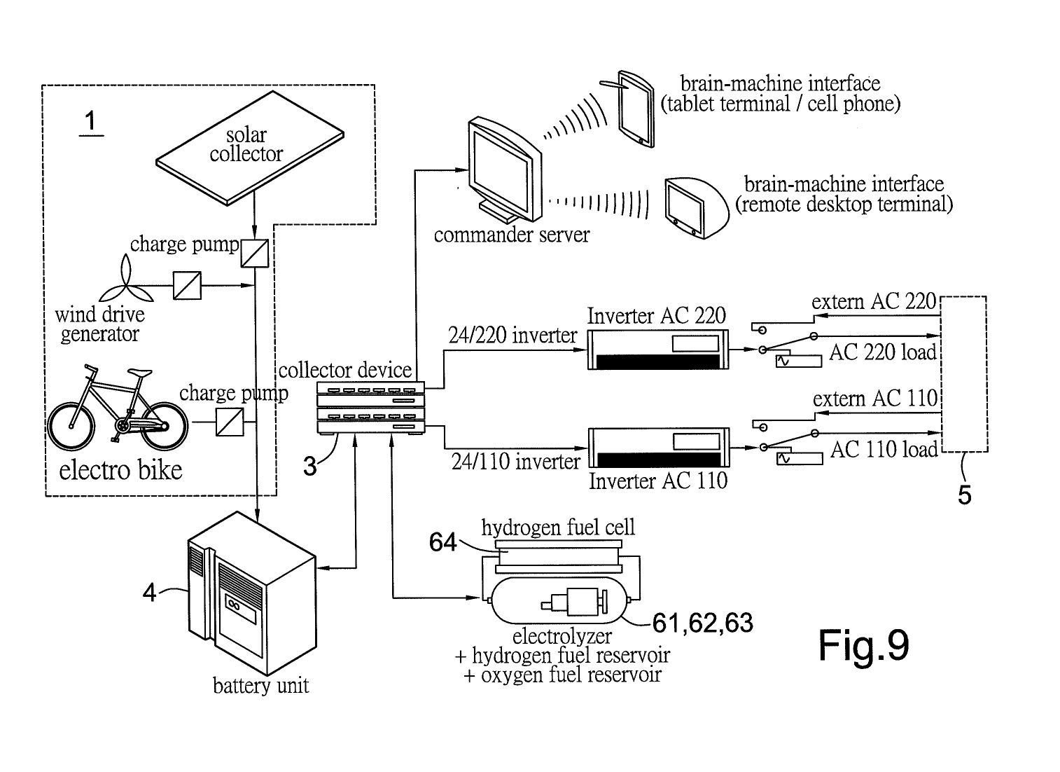

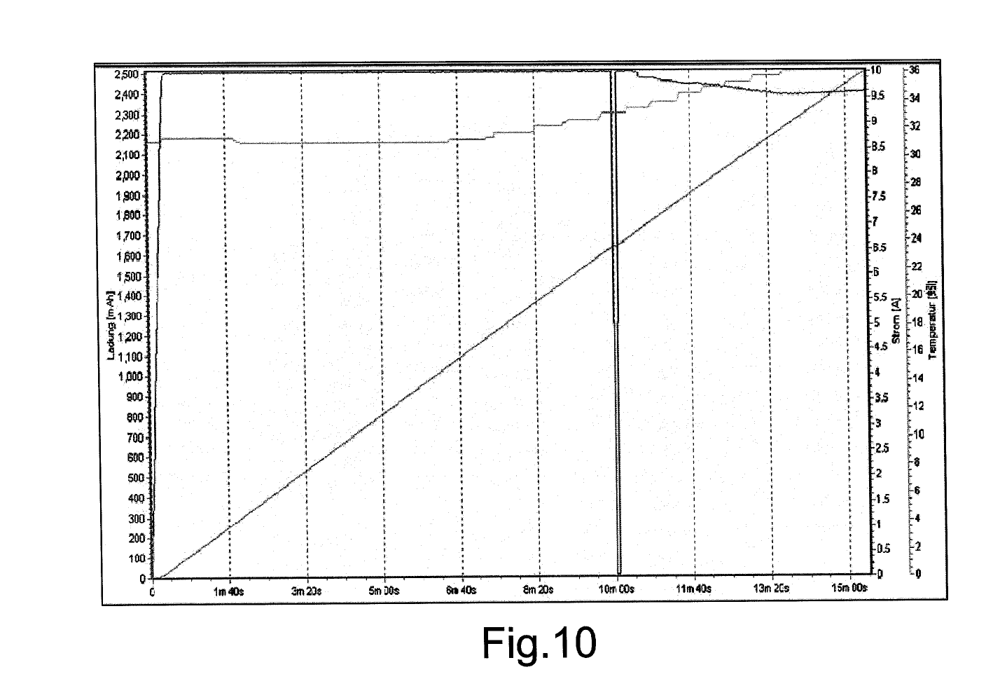

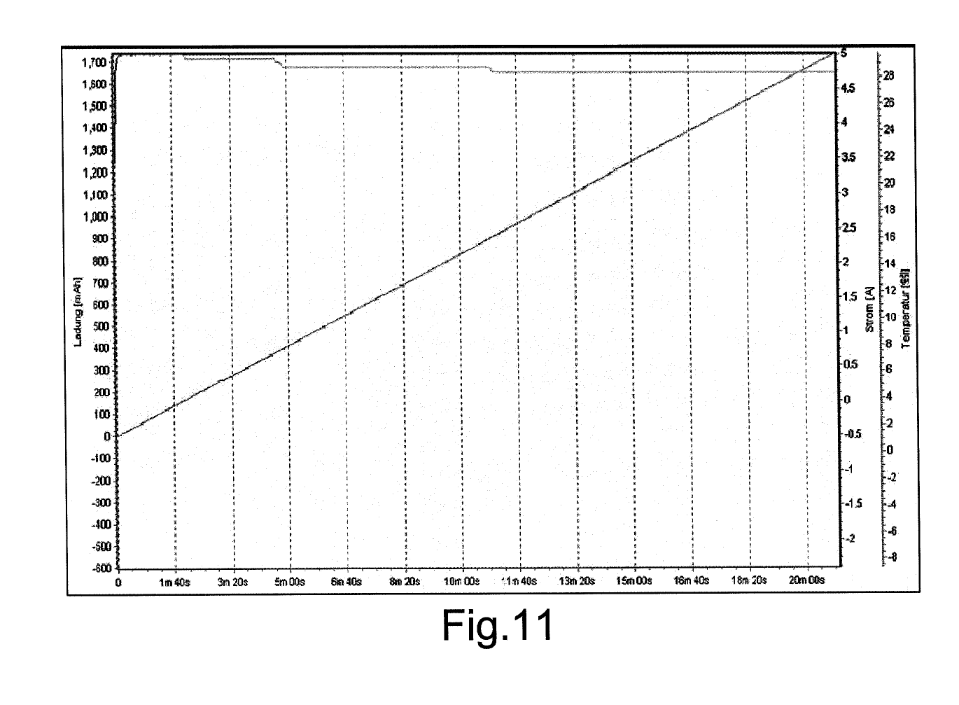

FIG. 8 is a schematic view showing control of the present invention. FIG. 9 is a schematic view showing how to distribute the energy produced by the present invention. FIG. 10 is a waveform diagram of the input device 1 charging the battery unit 4. This is the result of a simulation load test with a 200 w brushless DC motor, showing that the generator 2 is able to achieve a sufficient voltage and current at a relatively low speed to charge the battery unit 4. FIG. 11 is a waveform diagram of the battery unit 4 discharging to the output device 5.

The present invention has several noteworthy advantages, in particular:

1. Running distance of the electro-mobile bike at a time can be increased.

2. Electric energy produced by wind power and solar collector(s) can be stored in a battery unit for domestic use, therefore serving as a low voltage power source for cellphones, computers, lighting, or the like.

3. This energy producing system can provide electricity for rural areas which do not have electricity, serving as a power source for the modern small sized 3C electronic product or the like.

As for the outstanding functional effects of the present invention, it should be pointed out that:

1. It can control and supervise the generator and the output device intelligently.

2. It can automatically regulate and figure out the output/input capacity of the battery unit.

3. It can control the battery unit and the output device to output power smoothly.

4. It can securely control, figure out, and supervise the energy stored in the battery unit.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A balanced energy and energy producing system comprising:
an input device with a driven generator connected thereto; and
a control device having many stages of parameters and a battery monitoring parameter to be actuated by a signal of said driven generator,
wherein said control device supervises said generator to supply the electric energy needed for a battery unit and, based on the strength of said generator signal, drives an output device up to a predetermined power rating according to said many stages of parameters.

2. The system of claim 1, wherein said output device is a motor, the signal strength of said generator makes said control device to-regulate the strength of current of said battery unit supplied to said output device according to said many stages of parameters, so as to operate said output device in a selected transmission manner to reach a predetermined rated output speed value.

3. The system of claim 1, wherein said output device is a motor, said control device is further able to detect the revolution of said output device, the strength of said generator signal makes said control device regulate the strength of current of said battery unit supplied to said output device according to said many stages of parameters, so as to drive said output device in a selected transmission manner, said output device under operation indicates its revolution speed, and said control device regulates the revolution of said output device according to said many stages of parameters, thereby making the revolution of said output device reach the predetermined rated value.

4. The system of claim 1, wherein said output device is a domestic electric appliance, the strength of said generator signal makes said control device regulate the strength of current of said battery unit supplied to said output device according to said many stages of parameters, and said control device regulates the electricity produced by said output device with said many stages of parameters to reach the predetermined rated output current value.

5. The system of claim 1, wherein said output device is an electrolyzer which can perform an electrolyzing process in an electrolytic cell, said electrolytic cell further consists of a positive electrode and a negative electrode immersed in a solution containing positive and negative ions, wherein said positive and said negative electrodes are for producing oxygen and hydrogen, respectively.

6. The system of claim 5, wherein said positive and said negative electrodes are connected to an oxygen fuel reservoir and a hydrogen fuel reservoir, and said two reservoirs are respectively connected to a positive pole and a negative pole of said hydrogen fuel cell so as to allow said hydrogen fuel cell to output electricity continually.
